(19) United States
(12) Patent Application Publication
(10) Pub. No.: US 2014/0290913 A1
(43) Pub. Date: Oct. 2, 2014

(54) HEAT TRANSFER MODULE, HEAT PIPE, AND MANUFACTURING METHOD OF HEAT PIPE

(71) Applicant: Quanta Computer Inc., Taoyuan Shien (TW)

(72) Inventors: Yu-Nien HUANG, Zhongli City (TW); Cheng-Yu CHENG, Guishan Township (TW)

(73) Assignee: Quanta Computer Inc., Taoyuan Shien (TW)

(21) Appl. No.: 14/089,491

(22) Filed: Nov. 25, 2013

(30) Foreign Application Priority Data
Mar. 28, 2013 (TW) 102111186

(51) Int. Cl. F28D 15/04; B23P 15/26

(52) U.S. Cl. CPC F28D 15/04; B23P 15/26
USPC 165/104.26; 29/890.032

(57) ABSTRACT

A heat pipe includes a flat tube, a first capillary structure, a second capillary structure, and a capillary structure block. The flat tube has flat portions, a first arc portion and a second arc portion. The first arc portion and the second arc portion are respectively connected to the opposite sides of the flat portions. The first capillary structure is accommodated in the flat tube and is in contact with the first arc portion. The second capillary structure is accommodated in the flat tube, and is in contact with the second arc portion. The first and second capillary structures are spaced apart from each other, and define a gas flowing chamber therebetween. The capillary structure block is disposed on a partial area of the gas flowing chamber, and is in contact with the flat portions, the first and second capillary structures.

### CROSS-REFERENCE TO RELATED APPLICATIONS

This application claims priority to Taiwan Application Serial Number 102111186, filed Mar. 28, 2013, which is herein incorporated by reference.

### FIELD OF THE INVENTION

Embodiments of the present invention relate to a heat pipe. More particularly, embodiments of the present invention relate to a heat transfer module, a heat pipe and a manufacturing method thereof.

### BACKGROUND

A modern electronic device, such as the laptop and the tablet PC, generates significant heat during operation. If the heat cannot be not efficiently dissipated, the temperature of the electronic device rises, which the electronic device may have malfunctioned or even destroy the electronic components in the electronic device. Therefore, the heat dissipation device, such as the heat dissipation fan, is commonly equipped with the current electronic device.

To efficiently transfer thermal energy from the heat source (such as the electronic components) to the heat dissipation fan, the manufacturer usually interfaces a heat transfer device between the heat source and the heat dissipation fan. A heat pipe is a popular one of the heat transfer devices. The heat pipe includes capillary structures on the inner wall of the heat pipe, and the capillary structures contain working fluid therein. When one end of the heat pipe is positioned on a relative hot zone like the heat source, and another end is positioned on a relative cold zone like the heat dissipation fan, the working fluid around the relative hot zone evaporates into gas. The gas flows toward the relative cold zone in the pipe. When the gas arrives the relative cold zone, it condenses as liquid and is absorbed by the portion of the capillary structure around the relative cold zone. As such, the working fluid can be recycled to transfer the thermal energy.

Because the modern electronic device is designed as thin as possible, some manufacturers make the heat pipe in a flat shape. However, if the flat heat pipe is too thin to support the structure, when the heat source is attached to the heat pipe, the heat pipe may deform due to the pressing force from the heat source, and deteriorate its heat transfer ability. For overcoming this issue, some manufactures first assemble the heat pipe to a thermal conductive metal, and attach closely the thermal conductive metal to the heat source. Although the thermal conductive metal prevents the heat pipe from the deformation, the heat transfer path is thus lengthened, which reduces efficacy of the heat transfer.

### SUMMARY

A summary of various embodiments according to the present invention is disclosed below. It should be understood that these aspects are presented merely to provide the reader with a brief summary of these certain embodiments and that these aspects are not intended to limit the scope of this disclosure.

The present invention provides a flat heat pipe with a stronger structure, which not deforms when it suffers from an external force, and the heat transfer ability is not influenced.

One aspect of the present invention provides a heat pipe. Accordance with one embodiment of the present invention, the heat pipe includes a flat tube, a first capillary structure, a second capillary structure, and a capillary structure block.

The flat tube has a plurality of flat portions, a first arc portion and a second arc portion. The first arc portion and the second arc portion are respectively connected to the opposite sides of the flat portions. The first capillary structure is accommodated in the flat tube and is in contact with the first arc portion. The second capillary structure is accommodated in the flat tube, and is in contact with the second arc portion. The first capillary structure and the second capillary structure are spaced apart from each other, and define a gas flowing chamber therebetween. The capillary structure block is disposed on a partial area of the gas flowing chamber, and is in contact with the flat portions, the first capillary structure and the second capillary structure.

Another aspect of the present invention provides a heat transfer module. In accordance with one embodiment of the present invention, the heat transfer module includes a heat source and a heat pipe. The heat pipe is disposed on the heat source. The heat pipe includes a flat tube, a first capillary structure, a second capillary structure and a capillary structure block. The flat tube has a plurality of flat portions, a first arc portion and a second arc portion. The first arc portion and the second arc portion are respectively connected to the opposite sides of the flat portions. The first capillary structure is accommodated in the flat tube and is in contact with the first arc portion. The second capillary structure is accommodated in the flat tube and is in contact with the second arc portion. The first capillary structure and the second capillary structure are spaced apart from each other, and define a gas flowing chamber therebetween. The capillary structure block is disposed on a partial area of the gas flowing chamber, and is in contact with the flat portions, the first capillary structure and the second capillary structure.

Yet another aspect of the present invention provides a method for manufacturing the heat pipe. In accordance with one embodiment of the present invention, the method includes putting a first capillary structure and a second capillary structure on opposite sides within a non-flat tube; pressing the non-flat tube to form a flat tube, in which the flat tube has a plurality of flat portions, a first arc portion and a second arc portion, and the first arc portion and the second arc portion are respectively connected to the opposite sides of the flat portions, and the first capillary structure is in contact with the first arc portion, and the second capillary structure is in contact with the second arc portion, and the first capillary structure and the second capillary structure are spaced apart from each other, and define a gas flowing chamber therebetween; and putting a capillary structure block in a partial area of the gas flowing chamber, in which the capillary structure block is in contact with the flat portions, the first capillary structure and the second capillary structure.

In the foregoing embodiments, the capillary structure block can be in contact with the flat portions on the top and bottom sides thereof, and can also be in contact with the first capillary structure and the second capillary structure on the left and right sides thereof. Therefore, when the heat source presses against the flat portion of the flat tube, the capillary structure block can support the flat portion, thereby preventing the flat tube from deforming.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective view of the heat transfer module in accordance with one embodiment of the present invention;

FIG. 2 is a cross-sectional view taken along A-A′ line in FIG. 1;

FIG. 3 is a front view of the heat transfer module in FIG. 1;

FIG. 4 is a schematic view illustrating the heat transfer phenomenon occurring in the heat pipe in FIG. 2; and

FIGS. 5A to 5C are schematic views illustrating the method for manufacturing the heat pipe in accordance with one embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

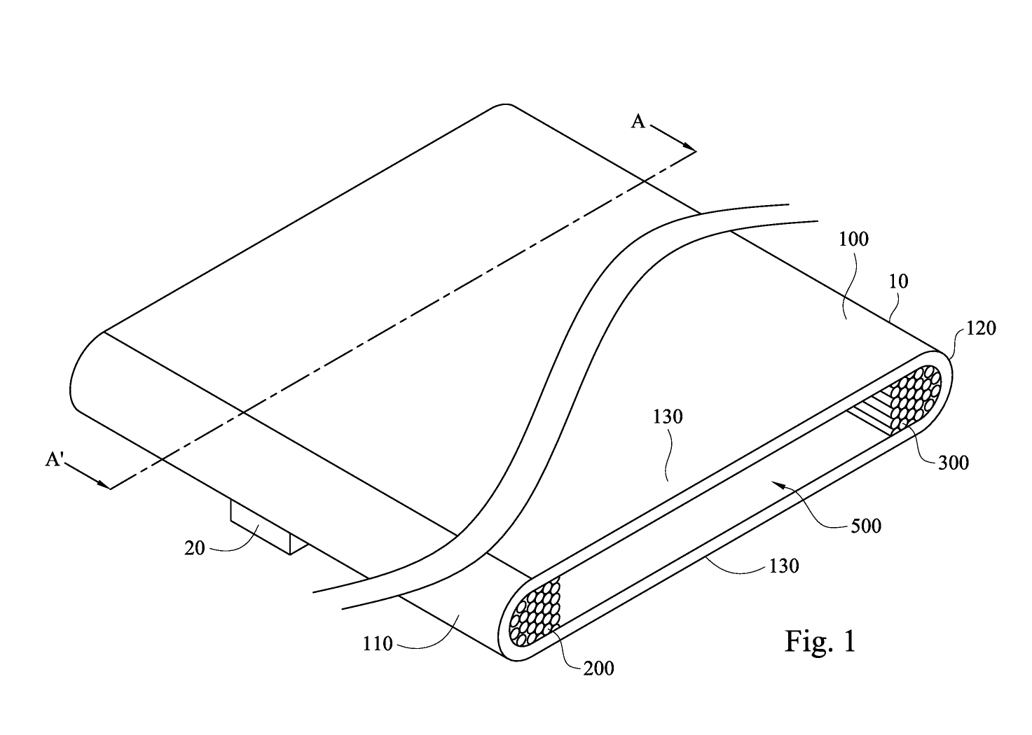

FIG. 1 is a perspective view of the heat transfer module in accordance with one embodiment of the present invention. As shown in FIG. 1, the heat transfer module includes a heat pipe 10 and a heat source 20. The heat pipe 10 is disposed on the heat source 20. The heat pipe 10 includes a flat tube 100, a first capillary structure 200 and a second capillary structure 300. The flat tube 100 has a plurality of flat portions 130, a first arc portion 110 and a second arc portion 120. The flat portions are parallel to each other and spaced apart from each other. The first arc portion 110 and the second arc portion 120 are respectively connected to the opposite sides of the flat portions 130, thereby forming a flat ring shape in cross-sectional view. The first capillary structure 200 is accommodated in the flat tube 100 and is in contact with the first arc portion 110. The second capillary structure 300 is accommodated in the flat tube 100 and is in contact with the second arc portion 120. The first capillary structure 200 and the second capillary structure 300 are spaced apart from each other, and define a gas flowing chamber 500 therebetween.

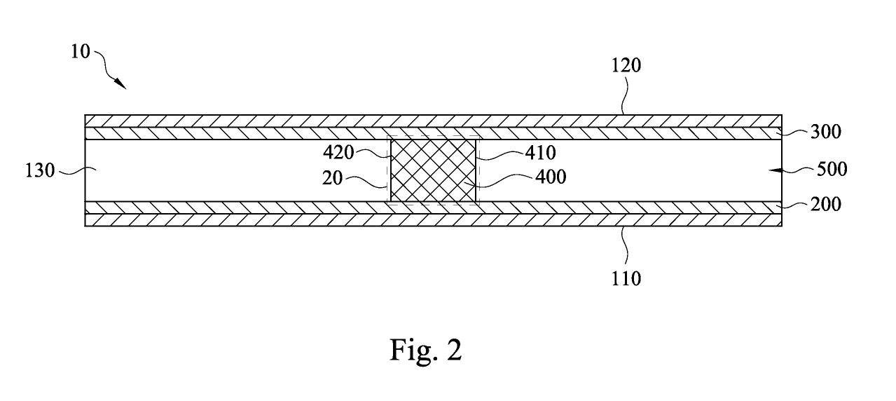

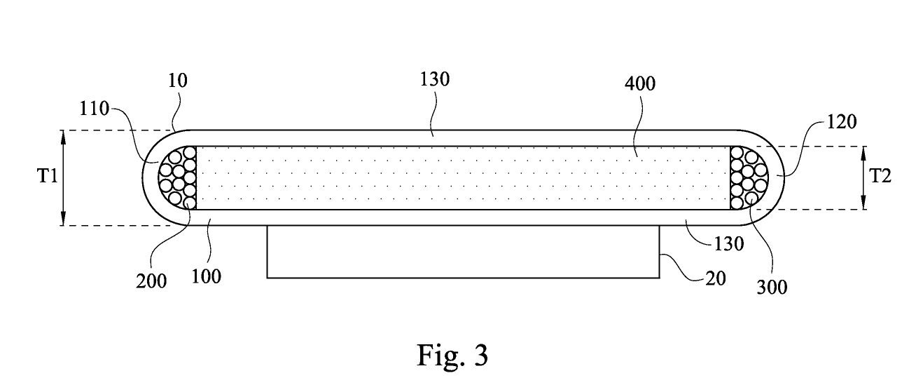

FIG. 2 is a cross-sectional view taken along A-A′ line in FIG. 1. FIG. 3 is a front view of the heat transfer module in FIG. 1. As shown in FIG. 2, the heat pipe 10 includes a capillary structure block 400. The capillary structure block 400 is disposed on a partial area of the gas flowing chamber 500. In particular, some area of the gas flowing chamber 500 has the capillary structure 400 thereon, and the rest area doesn't have the capillary structure 400 thereon, and is an empty chamber. As shown in FIG. 3, the capillary structure block 400 is in contact with the flat portions 130, the first capillary structure 200 and the second capillary structure 300.

As shown in FIG. 3, because the capillary structure block 400 can be in contact with the flat portions 130 on the top and bottom sides thereof, and can also be in contact with the first capillary structure 200 and the second capillary structure 300 on the left and right sides thereof. Therefore, when the heat source 20 presses against the flat tube 100, the capillary structure block 400 can support the flat tube 100, thereby preventing the flat tube 100 from deforming. As such, even though the flat tube 100 is thin, it will not deform when suffering from the pressing force from the heat source 20.

In some embodiments, as shown in FIG. 3, the thickness T1 of the flat tube 100 satisfies: 0.6 mm≦T1≦0.8 mm. The thickness T2 of the capillary structure 400 and the gas flowing chamber 500 (See FIG. 1) satisfies: 0.3 mm≦T2≦0.5 mm. Therefore, if the thickness T1 of the flat tube 100 is less than 1 mm, the gas flowing chamber 500 can still provide enough space for the flowing working fluid that is in the gaseous state.

In some embodiment, as shown in FIG. 3, because the capillary structure 400 supports the flat tube 100, the flat tube 100 can be in contact with the heat source 20 without any metal block intervening between the flat tube 100 and the heat source 20. In other words, in some embodiments, the flat portion 130 of the flat tube 100 can be in direct contact with the heat source 20, so as to improve the heat transfer ability.

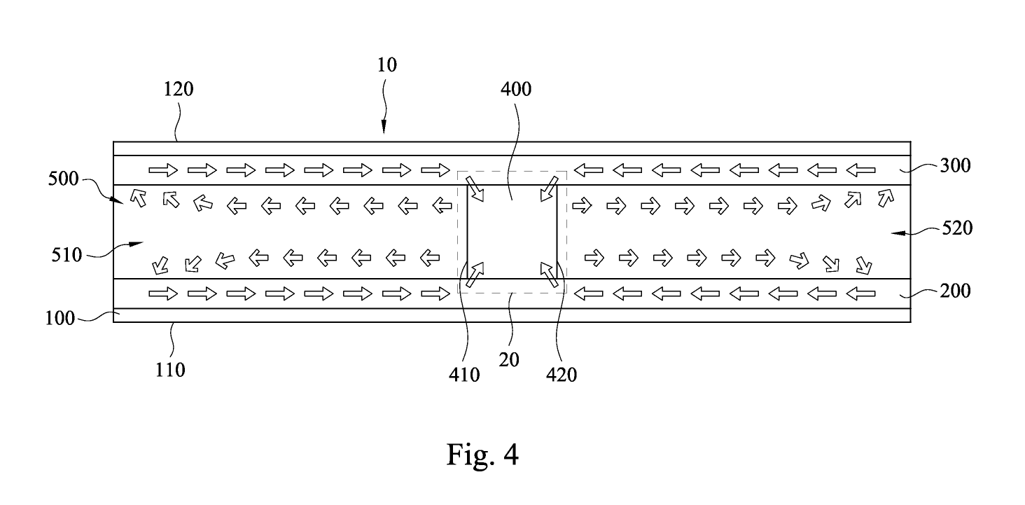

FIG. 4 is a schematic view illustrating the heat transfer phenomenon occurring in the heat pipe 10 in FIG. 2. As shown in FIG. 4, the heat pipe 10 can be filled with the working fluid, such as the water or the liquid having low viscosity. The working fluid can flow in the first capillary structure 200, the second capillary structure 300 and the capillary structure block 400 by the capillary phenomenon. The capillary structure block 400 has two opposite lateral walls 410 and 420. The lateral walls 410 and 420 are both exposed to the gas flowing chamber 500. The capillary structure block 400 can separate the gas flowing chamber 500 as a first gas flowing sub-chamber 510 and a second gas flowing sub-chamber 520. The first gas flowing sub-chamber 510 and the second gas flowing sub-chamber 520 are not spatially communicated. The lateral wall 410 is exposed to the first gas flowing sub-chamber 510, and the lateral wall 420 is exposed to the second gas flowing sub-chamber 520. When the capillary structure block 400 is positioned on a relative hot position, such as the position in the heat pipe 10 closest to the heat source 20 (See FIG. 3), the working fluid in the capillary structure block 400 receives the thermal energy and thereby evaporates as in the gaseous state. The working fluid in the gaseous state escapes out of the capillary structure block 400 via the lateral walls 410 and 420, and flows into the first gas flowing sub-chamber 510 and the second gas flowing sub-chamber 520. When the working fluid in the first gas flowing sub-chamber 510 arrives at the relative cold position, such as the position in the first gas flowing sub-chamber 510 farthest away from the capillary structure block 400, the working fluid condenses as the liquideous state, and is absorbed by the first capillary structure 200 and the second capillary structure 300. The working fluid in the liquideous state can flow toward the capillary structure block 400 by the capillary phenomenon. A heat dissipation fan can be disposed on the relative cold position, so as to dissipate the heat. By the recycling the working fluid, the thermal energy from the heat source 20 (See FIG. 3) can be transferred to the position of the heat pipe 10 away from the heat source 20, so that the heat transfer effect can be implemented.

In some embodiments, as shown in FIG. 4, the projection position that the capillary structure block 400 perpendicularly projected to the plane that the heat source 20 is positioned at least partially overlaps with the heat source 20. In other words, the capillary structure block 400 is positioned exactly above or under the heat source 20, so that the heat transfer path between the heat source 20 and the capillary structure block 400 can be shortened. In particular, the manufacturer can vary the position of the capillary structure block 400 in the gas flowing chamber 500 based on the position of the heat source 20. For example, if the heat source 20 is positioned on the left side of the heat pipe 10, the manufacturer can move the capillary structure block 400 to the left part of the gas flowing chamber 500, so as to make the capillary structure block 400 positioned exactly above or under the heat source 20, thereby efficiently transfer the thermal energy from the heat source 20.

In some embodiments, as shown in FIG. 4, the length of the capillary structure block 400 is less than the length of the flat tube 100. Further, the length of the first capillary structure 200 and the length of the second capillary structure 300 substantially equals to the length of the flat tube 100. In other words, the length of the capillary structure block 400 is less than the length of the first capillary structure 200 and the length of the second capillary structure 300, so as to separate the gas flowing chamber 500 as the first gas flowing sub-chamber 510 and the second gas flowing sub-chamber 520.

In some embodiments, the normal line of the lateral wall 410 of the capillary structure block 400 exposed to the first gas flowing sub-chamber 510 is substantially parallel the lengthwise direction of the flat tube 100. Similarly, the normal line of the lateral wall 420 of the capillary structure block 400 exposed to the second gas flowing sub-chamber 520 is substantially parallel the lengthwise direction of the flat tube 100.

It is understood that the “length” of an object in this context refers to the size of the longest edge of the object. It is further understood that the “lengthwise direction” in this context refers to the direction parallel to the longest edge.

It is understood that the term “substantially” in this context refers that the variation not affecting the essence of the invention can be covered. For example, the description “the length of the first capillary structure 200 substantially equals to the length of the flat tube 100” not only refers that the length of the first capillary structure 200 is exactly equal to the length of the flat tube 100, but also refers that the length of the first capillary structure 200 can be slightly less than the length of the flat tube 100 as long as the length of the first capillary structure 200 is not less than the length of the capillary structure block 400.

In some embodiments, the first capillary structure 200, the second capillary structure 200 and the capillary structure block 400 refers to the structure that allows the fluid flowing therein by the capillary phenomenon. For example, the first capillary structure 200, the second capillary structure 300 and the capillary structure block 400 can be a structure having grooves, a mesh structure or a sintered structure. Preferably, the first capillary structure 200 and the second capillary structure 300 can be non-sintered fibers, which is more flexible than the sintered fibers, so as to make the heat pipe 10 thinner, such as pressing the heat pipe 10 to be flat. In some embodiment, the capillary structure block 400 can be a sintered structure, such as the sintered metal. As shown in FIG. 3, because the capillary structure block 400 can press the first capillary structure 200 on the first arc portion 110, it can fasten the first capillary structure 200; similarly, because the capillary structure block 400 can press the second capillary structure 300 on the second arc portion 120, it can fasten the second capillary structure 300.

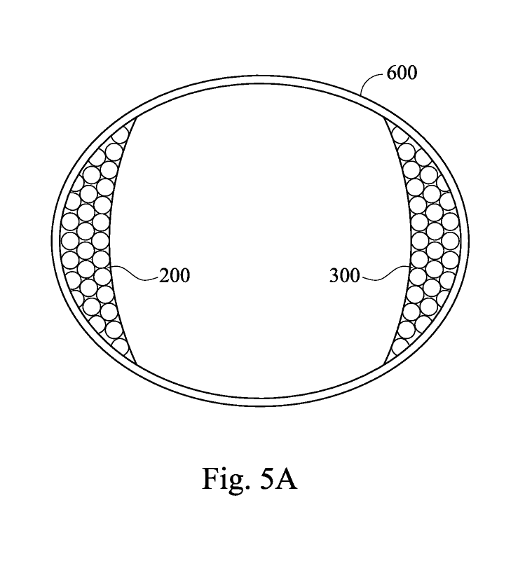

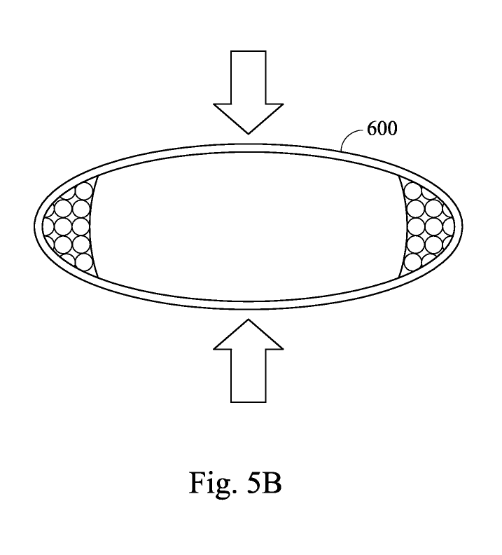

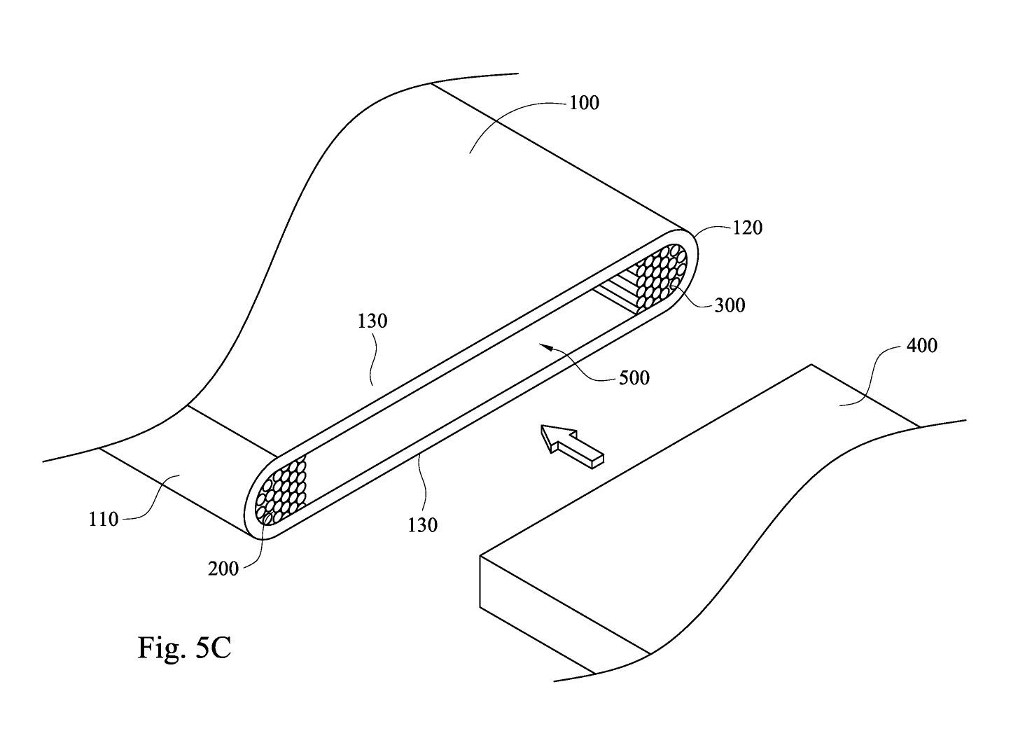

FIGS. 5A to 5C are schematic views illustrating the method for manufacturing the heat pipe in accordance with one embodiment of the present invention. As shown in FIG. 5A, the first capillary structure 200 and the second capillary structure 300 can be put on opposite sides within a non-flat tube 600. Preferably, the first capillary structure 200 and the second capillary structure 300 can be non-sintered fibers.

As shown in FIG. 5B, after putting the first capillary structure 200 and the second capillary structure 300, the non-flat tube 600 can be pressed to form the flat tube 100. The specific structure of the flat tube 100 is shown in FIG. 1 and the foregoing related description, and is not described repeatedly herein.

As shown in FIG. 5C, when forming the flat tube, the capillary structure block 400 can be put in a partial area of the gas flowing chamber 500, and be put as in contact with the flat portions 130, the first capillary structure 200 and the second capillary structure 300.

In some embodiments, the capillary structure block 400 can be sintered before it is put into the gas flowing chamber 500.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A heat pipe, comprising:
a flat tube having a plurality of flat portions, a first arc portion and a second arc portion, wherein the first arc portion and the second arc portion are respectively connected to the opposite sides of the flat portions;
a first capillary structure accommodated in the flat tube and being in contact with the first arc portion;
a second capillary structure accommodated in the flat tube, and being in contact with the second arc portion, wherein the first capillary structure and the second capillary structure are spaced apart from each other, and define a gas flowing chamber therebetween; and
a capillary structure block disposed on a partial area of the gas flowing chamber, and being in contact with the flat portions, the first capillary structure and the second capillary structure.

2. The heat pipe of claim 1, wherein two lateral walls of the capillary structure block opposite to each other are both exposed to the gas flowing chamber.

3. The heat pipe of claim 1, wherein the length of the capillary structure block is less than the length of the first capillary structure and the length of the second capillary structure.

4. The heat pipe of claim 1, wherein the first capillary structure and the second capillary structure are non-sintered fibers.

5. A heat transfer module, comprising:
a heat source; and
a heat pipe disposed on the heat source, the heat pipe comprising:
a flat tube having a plurality of flat portions, a first arc portion and a second arc portion, wherein the first arc portion and the second arc portion are respectively connected to the opposite sides of the flat portions;
a first capillary structure accommodated in the flat tube and being in contact with the first arc portion;
a second capillary structure accommodated in the flat tube, and being in contact with the second arc portion, wherein the first capillary structure and the second capillary structure are spaced apart from each other, and define a gas flowing chamber therebetween; and
a capillary structure block disposed on a partial area of the gas flowing chamber, and being in contact with the flat portions, the first capillary structure and the second capillary structure.

6. The heat transfer module of claim 5, wherein the projection position that the capillary structure block perpendicularly projected to the plane that the heat source is positioned at least partially overlaps with the heat source.

7. The heat transfer module of claim 5, wherein the flat tube is in contact with the heat source.

8. The heat transfer module of claim 5, wherein two lateral walls of the capillary structure block opposite to each other are both exposed to the gas flowing chamber.

9. The heat transfer module of claim 5, wherein the length of the capillary structure block is less than the length of the first capillary structure and the length of the second capillary structure.

10. The heat transfer module of claim 5, wherein the first capillary structure and the second capillary structure are non-sintered fibers.

11. A method for manufacturing a heat pipe, comprising:
putting a first capillary structure and a second capillary structure on opposite sides within a non-flat tube;
pressing the non-flat tube to form a flat tube, wherein the flat tube has a plurality of flat portions, a first arc portion and a second arc portion, wherein the first arc portion and the second arc portion are respectively connected to the opposite sides of the flat portions, wherein the first capillary structure is in contact with the first arc portion, and the second capillary structure is in contact with the second arc portion, wherein the first capillary structure and the second capillary structure are spaced apart from each other, and define a gas flowing chamber therebetween; and
putting a capillary structure block in a partial area of the gas flowing chamber, wherein the capillary structure block is in contact with the flat portions, the first capillary structure and the second capillary structure.

12. The method for manufacturing the heat pipe of claim 11, further comprising:
sintering the capillary structure block before putting the capillary structure block into the gas flowing chamber.
